(19) United States
(12) Patent Application Publication
(10) Pub. No.: US 2007/0137802 A1
(43) Pub. Date: Jun. 21, 2007

(54) Protective shutter panel

(76) Inventors: David W. Lukasik, Spring Lake, MI (US); Charles B. Tebbe, Holland, MI (US)

Correspondence Address: JOHN W. HARBST, 1180 LITCHFIELD LANE, BARTLETT, IL, 60103, US

(21) Appl. No.: 11/312,321

(22) Filed: Dec. 20, 2005

(51) Int. Cl. E06B 3/12

(52) U.S. Cl. 160/235

(57) ABSTRACT

A protective shutter assembly for a roll-type shutter assembly. The shutter assembly includes a plurality of one-piece plate members pivotally joined to each other along adjacent edges. Each plate member has first and second longitudinal edges and an intermediate portion terminating in spaced ends and having a transverse cross-sectional configuration so as to allow approximately 50 mm of displacement of the intermediate portion when a 2″×4″ wood object traveling at a 55 mph velocity impact against it. The plate member has a first hinge portion along the first edge thereof. The first hinge portion includes a first open-sided channel which opens to a pocket defined by hook. Each plate member also has a second hinge portion along the second edge thereof. The second hinge portion also defines an open-sided channel and a hook. The hook on the first hinge portion is configured to matingly and pivotally engage with the hook on the second hinge portion of an adjacent protective shutter panel in a hinge joint configured to allow for up to about 90° of rotation between the adjacent and pivotally joined shutter panels. Preferably, each plate member further includes structure for inhibiting inadvertent separation of the first and second hinge portions on adjacent panels relative to each other.

### FIELD OF THE INVENTION

The present invention generally relates to roll-type shutter panels and, more specifically, to a protective shutter panel for covering a door or window opening and which is configured to yield minimal displacement from objects propelled toward the protective shutter panel at velocities up to and exceeding of 55 mph.

### BACKGROUND OF THE INVENTION

Conventional roll-type shutter assemblies are used to cover door and/or window openings in buildings. Conventionally, a protective shutter assembly overlies a door or window so as to provide security and to protect against damage due to flying objects. Such shutter assemblies are commonly used to provide storm protection in areas which are prone to hurricanes. In such areas, when heavy winds blow, it is common to arrange such shutter assemblies over windows and doors by unrolling the shutter assembly. Thus, debris which may be propelled at extremely high speeds by hurricane force winds are inhibited from piercing the doors and windows of a building protected by such shutter assemblies. Additionally, and when disposed in covering relation relative to a window or door, such shutter assemblies protect against unlawful entry such as by unlawfully breaking a window or door.

A conventional roll-type shutter assembly includes a plurality of relatively thin and narrow horizontally elongated plate members. The plate members are vertically aligned one above the other and are hingedly interconnected to each other along their adjacent edges. When the shutter assembly is opened, the plate members are arranged in a generally vertical plane for providing a closure, with each plate member being suspended from the adjacent plate member next above it by the hinge connection therebetween. When opened, the plate members of the shutter assembly roll-up about an axis which can be in the form of an interior axle or shaft. As they move toward a closed or rolled-up position, the adjacent plate members pivot relative to each other.

Although conventional roll-up shutter assemblies are relatively strong, they are susceptible to penetration or breakage when an object is propelled at sufficiently high speeds toward the shutter assembly. That is, a rapidly moving object, such as wind hurled debris thrown by high velocity, hurricane force winds, have been known to frequently penetrate or break the plate member apart from one another, particularly at the pivotal connection between such plate members. On the other hand, the panel members must be light enough in weight such that the shutter assembly can be moved between open and closed positions. Moreover, the plate members comprising such shutter assemblies must be of like kind to allow them to readily fit together and must be economical to manufacture and produce.

Accordingly, and especially in areas which are subject to hurricane strength winds and where wind hurled objects are a danger, there is a continuing need and desire for a protective shutter assembly comprised of a series of plate members which can withstand penetration by such objects while offering minimal displacement when struck by flying objects.

### SUMMARY OF THE INVENTION

In view of the above, and according to one aspect, there is provided a roll-type protective shutter assembly for covering a door/window opening. The shutter assembly includes a plurality of one-piece plate members pivotally joined to each other along adjacent edges. Each plate member has first and second longitudinal edges. Each plate member also has an intermediate portion terminating in spaced ends and having a transverse cross-sectional configuration so as to allow a maximum of 50 mm displacement of the plate member when objects traveling at a 55 mph velocity impact against it. The plate member has a first hinge portion along the first edge thereof. The first hinge portion includes a spiral-like hook which combines with a confronting surface on the plate member to define a first open-sided channel and pocket. Each plate member also has a second hinge portion along the second edge thereof. The second hinge portion includes a spiral-like hook defining a second open-sided channel. The pocket in the first hinge portion is configured to matingly and pivotally engage with the second hinge portion on an adjacent protective shutter panel in a hinge joint configured to allow for up to about 90° of rotation between the adjacent and pivotally joined shutter panels. As will be appreciated from an understanding of the invention, such 90° of rotation between the adjacent and pivotally joined shutter panels allows them to be rolled-up and moved to an open position wherein one plate member is arranged substantially vertically above the other. Each plate member further includes structure for inhibiting inadvertent separation of the first and second hinge portions on adjacent panels relative to each other.

In a preferred embodiment, the intermediate portion of each plate member has a generally curvilinear outer surface configuration between the first and second longitudinal edges. To promote interchangeability, the plate member is preferably formed using an extrusion process. The thickness of material used to form each plate members ranges in thickness between about 0.1.5 mm to about 3 mm. Moreover, in preferred embodiment, each plate member has a weight of about one-half pound per foot.

The open-sided channel defined by the first hinge portion is sized equal to or slightly larger than a cross-sectional thickness of material between inner and outer surfaces of that portion of the plate member extending toward the second hinge portion. According to another preferred embodiment, an outer surface of the spiral-like hook at the second hinge portion has a curvature which is equal to or slightly smaller in cross-sectional size than the pocket defined at the first hinge portion so as to allow the first and second hinge portions of adjacent panels to slide longitudinally one within the other.

In one form, at least a transverse section of the intermediate portion of the plate member has a generally triangular configuration between the first and second longitudinal edges of the plate member. The plate member can further be designed, between the first and second longitudinal edges, with an opening for receiving and captively holding a connector of a securement apparatus used to movably attach the panels of the shutter assembly to adjacently disposed rails/tracks on opposed sides of the door/window opening to be covered by such roll-type shutter assembly. To reduce the weight of the plate member without adversely affecting strength characteristics thereof, the intermediate portion of the plate member preferably has an opening with a closed margin transversely extending between the first and second longitudinal edges of the plate member. With such design, the closed margin of the opening transversely extending between said first and second longitudinal edges of the plate member is configured to longitudinally receive and captively hold the securement apparatus connector used to attach the panels of the shutter assembly to the adjacently disposed rails/tracks on opposed sides of the door/window opening to be covered by such roll-type shutter assembly.

According to another aspect, there is provided a protective shutter panel for a roll-type shutter assembly. The protective shutter panel includes a unitary plate member having first and second longitudinal edges with a body portion extending between those edges and including inner and outer surfaces. The plate member body portion terminates in longitudinally spaced ends and has a configuration so as to allow a maximum of 50 mm displacement when objects traveling at a 55 mph velocity impact thereagainst. The plate member has a first hinge portion along the first edge thereof. The first hinge portion includes a spiral-like and free-ended hook which combines with a confronting surface on the plate member to define a first open-sided channel leading and opening to a pocket. The plate member also has a second hinge portion along the second edge thereof. The second hinge portion includes a spiral-like and free-ended hook defining a second open-sided channel. The open-sided channels defined by the first and second hinge portions allow the free-ended first and second hinge portions of adjacent panels to be interlocked relative to each other while permitting the adjacent panels members to rotate through an arc of about 90° relative to each other. The plate member further includes structure for inhibiting inadvertent separation of said first and second free ended hinge portions on adjacent panels relative to each other.

In a preferred form, the outer surface of the body portion of the plate member has a generally curvilinear configuration between the first and second longitudinal edges. In one form, each hinge portion terminates relative to the respective confronting surface so as to allow the first and second hinge portions to slide longitudinally one within the other. In one form, an outer surface of the spiral-like hook at the second hinge portion has a curvature which is equal to or slightly smaller in cross-sectional size than the pocket defined by the first hinge portion so as to allow the panels to be interconnected as through an endwise sliding movements.

To add strength to the panel, a transverse width section of the plate member body portion preferably has a generally triangular cross-sectional configuration between the first and second longitudinal edges thereof. In one form, the body portion of the plate member defines, between the first and second longitudinal edges, an opening configured to receive and captively hold a connector of a securement apparatus used to movably attach the panels of the shutter assembly to adjacently disposed rails/tracks on opposed sides of the door/window opening to be covered by such roll-type shutter assembly. In another form, the body portion of the plate member has an opening with a closed margin transversely extending between the first and second longitudinal edges of the plate member.

According to another aspect, there is provided a protective shutter panel for roll-type shutter assembly. The shutter panel includes a horizontally elongated one-piece plate member having an upper longitudinal edge, a lower longitudinal edge, and a body portion transversely extending between the edges and terminating in longitudinally spaced ends. The plate member body portion defines a forward face and a rear face. The plate member upper edge is formed with a first hook having a spiral-like curved portion terminating in a free end portion which is directed generally toward the lower marginal edge of the plate member. Moreover, the first hook combines with the plate member to define a first open sided channel. The plate member lower edge is formed with a second hook having a spiral-like curved portion terminating in a free end portion which is directed generally toward the rear face of the plate member. The first hook combines with the plate member to define a first open sided channel, and wherein the second hook combines with the plate member to define a second open sided channel. The open-sided channels defined by the first and second hooks and the plate member are configured to allow adjacent shutter panels to be interlocked relative to each other while permitting the adjacent shutter panels to rotate through an arc of about 90° relative to each other. The plate member further includes structure for inhibiting inadvertent separation of the first and second free ended hooks on adjacent shutter panels relative to each other.

The hooks and channels each preferably extend substantially continuously along an entire length of their respective shutter panel. In one form, the plate member is formed from a thin walled extrusion with a section of the body portion of the plate member being hollow.

In one form, the plate member body portion member defines, between the upper and lower longitudinal edges, an opening configured to longitudinally receive and captively hold a shutter panel connector. Preferably, the main body portion of the plate member has an opening with a closed margin transversely extending between the forward face and rear face and between the upper and lower longitudinal edges of the plate member. In one form, the closed margin of the opening transversely extending between the upper and lower longitudinal edges of the plate member is configured to longitudinally receive and captively hold a roller bearing shaft for said shutter panel therewithin for rotation about a fixed axis.

According to another aspect, there is provided a method of making a protective shutter panel for a roll-up shutter assembly, comprising the steps of: extruding a panel having first and second generally parallel and longitudinally extending edges, with the panel also having an intermediate portion terminating in longitudinally spaced ends and having a transverse cross-sectional configuration so as to allow a maximum of 50 mm displacement of the intermediate portion when a 9 lb. object traveling at a 55 mph velocity impacts thereagainst. The panel has a first hinge portion along the first edge thereof, with the first hinge portion including a spiral-like hook which combines with a surface on the panel to define a first open-sided channel leading to a pocket. The panel also has a second hinge portion along the second edge thereof. The second hinge portion includes a spiral-like hook defining a second open-sided channel. The pocket defined by the first hinge portion is configured to matingly and pivotally engage with the spiral-like hook of the second hinge portion on an adjacent protective shutter panel in a hinge joint configured to allow for up to about 90° of rotation between the adjacent and pivotally joined shutter panels.

One feature of the present invention relates to a protective shutter panel for dwellings, commercial establishments and the like which is relatively light weight, simple to manufacture and yet offers protection and minimal deflection protection against objects traveling at a 55 mph. velocity and impacting against the panel.

Another feature of this invention relates to the provision of a simplified design for reinforcing and rigidifying relatively lightweight plate members forming a roll-type protective shutter panel assembly.

Still another feature of the present invention relates to providing a plate member for a roll-type shutter assembly which allows for relatively large tolerances without affecting design performance and which provides for a substantially increased protection against forcible impacts from objects which might otherwise penetrate or severely damage conventional slat design.

These and other features, aims and advantages of the present invention will become more readily apparent from the following detailed description, the drawings, and appended claims.

### DESCRIPTION OF THE DRAWINGS

FIG. 1 is a side view of a portion of a roll-type protective shutter assembly showing a plurality of shutter panels embodying features of the present invention arranged in a generally vertical plane for covering and extending across an opening in a dwelling;

FIG. 2 is a side view of a portion of the roll-up type shutter assembly shown in FIG. 1 in a rolled-up or raised position for uncovering an opening in a dwelling;

FIG. 3 is a side view of one form of shutter panel embodying features of the invention;

FIG. 4 is a fragmentary front elevation view of the shutter panel shown in FIG. 3;

FIG. 5 is an enlarged fragmentary side view of a first hinge portion arranged toward a first edge of the panel shown in FIG. 3;

FIG. 6 is a is an enlarged fragmentary side view of a second hinge portion arranged toward the second edge of the panel shown in FIG. 3;

FIG. 7 is an enlarged fragmentary side view of a hinge joint between two adjacent shutter panels;

FIG. 8 is a view similar to FIG. 3 illustrating a second embodiment of the invention; and

FIG. 9 is a fragmentary front elevation view of the shutter panel shown in FIG. 8.

### DETAILED DESCRIPTION OF THE INVENTION

While the present invention is susceptible of embodiment in multiple forms, there is shown in the drawings and will hereinafter be described preferred embodiments of the invention, with the understanding the present disclosure is to be considered as setting forth an exemplification of the invention which is not intended to limit the invention to the specific embodiment illustrated and described.

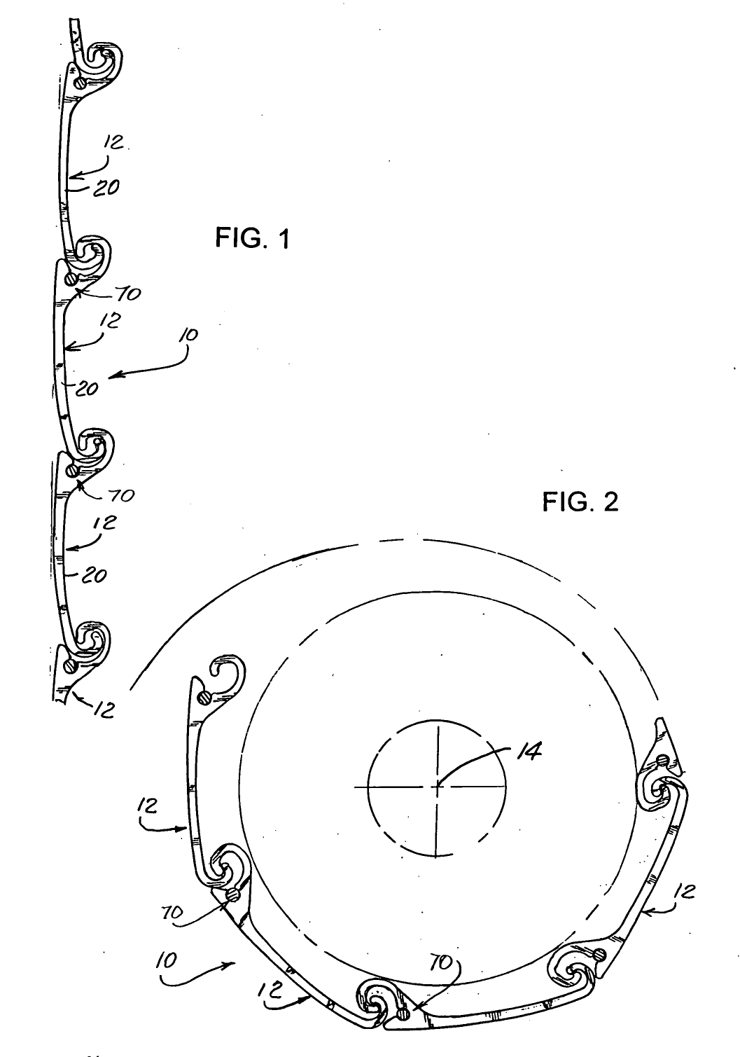

Referring now to the drawings, wherein like reference numerals indicate like parts throughout the several views, there is shown in FIG. 1 a roll-type shutter assembly, generally identified by reference numeral 10. As shown, the roll-type shutter assembly includes a plurality of shutter panels 12 which, in one position (FIG. 1), are vertically suspended, one from the other to form a closure or door, with each shutter panel being operably connected to the one above it.

As shown in FIG. 2, the shutter panels 12 comprising shutter assembly 10 are capable of being moved into a rolled-up configuration where they are wound around a central axis 14. For purposes of illustration only, the roll-type shutter assembly 10 is shown as including four shutter panels. It should be appreciated, however, the roll-type shutter assembly 10 can include any different number of shutter panels than that shown without detracting or departing from the spirit and scope of the present invention.

The central axis 14, shown schematically in FIG. 2, would generally be formed of an axle or shaft or a roller which operably connects to, and extends along an upper edge of the shutter assembly 10 and about which the panels 12 of the shutter assembly 10 are wound. Since such a roller or shaft is of a conventional and well known design, and forms no part of the present invention, no further description is required for such conventional structure.

Preferably, and to reduce the overall costs of the roll-type shutter assembly 10, the panels 12 comprising a particular assembly 10 are substantially identical. In one form, each shutter panel 12 forming assembly 10 is formed from a relatively thin walled, one-piece or unitary plate member 20. Plate member 20 is preferably formed using an extrusion process. As such, each panel 12 is preferably identical to each other, thus, promoting interchangability between panel members. Plate member 20 can be formed from any suitable material i.e., plastic or metal. In a most preferred form, and to significantly enhance the strength characteristics of the shutter panel, each plate member 20 is formed from aluminum.

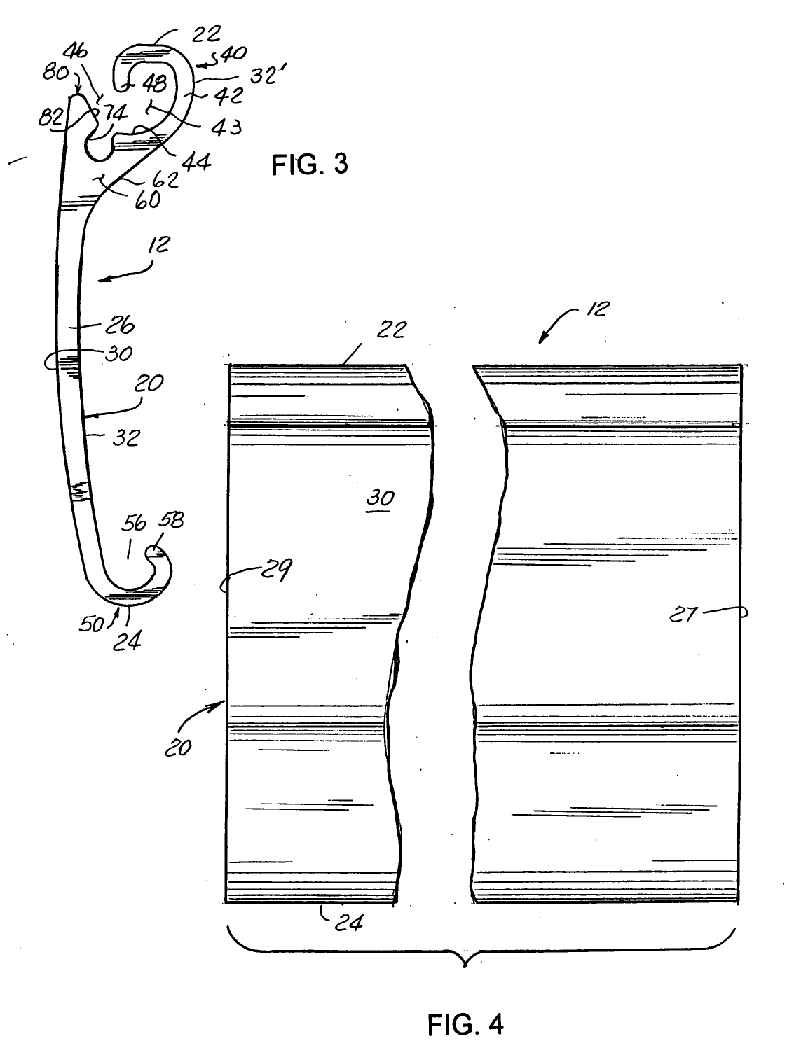

As shown in FIG. 3, each plate member 20 has a first or upper longitudinally extending edge 22 and a second or lower longitudinally extending edge 24 transversely spaced from and extending generally parallel to edge 22. Each plate member 20 also includes an intermediate or body portion 26 extending transversely between edges 22 and 24 and terminating in longitudinally spaced and generally parallel sides or ends 27 and 29 (FIG. 4) defining the horizontal length of each panel 12 therebetween. To promote the versatility of the invention, both the transverse or vertical distance between the upper and lower edges 22 and 24, respectively, and the horizontal distance between the ends 27 and 29 of each panel 12 can vary depending upon the particular application. Suffice it to say, the panels 12 comprising assembly 10 are designed to cover and provide protection to either a window or door opening of a dwelling (not shown).

It should be appreciated, the intermediate or body portion 26 of each plate member 20 can take on a myriad of different designs or configurations from that illustrated in the drawings without detracting or departing from the true spirit and scope of the present invention. For example, copending U.S. patent application Ser. No. 29/238,951, filed Sep. 23, 2005, with the applicable portions of which are incorporated herein by reference, disclose a few of the multiple alternative designs which could be used for the body portion 26 of each plate member 20.

Suffice it to say, in the illustrated embodiment, the intermediate or body portion 26 of each plate member 20 has a forward or front face 30 and a rearward or back face 32. In the embodiment illustrated in FIG. 3, the front face 30 and back face 32 are generally parallel to each other and each has a curvilinear configuration in cross-section. Such shutter assemblies are commonly used in warm areas, such as Florida, for security protection as well as storm protection and, therefore, are intended to blend into the decor of the structure upon which they are mounted. As such, at least the forward or front face 30 of each plate member 20 is preferably painted or coated to enhance the ability of the assembly 10 to blend with the particular decor of the dwelling or structure upon which they are mounted.

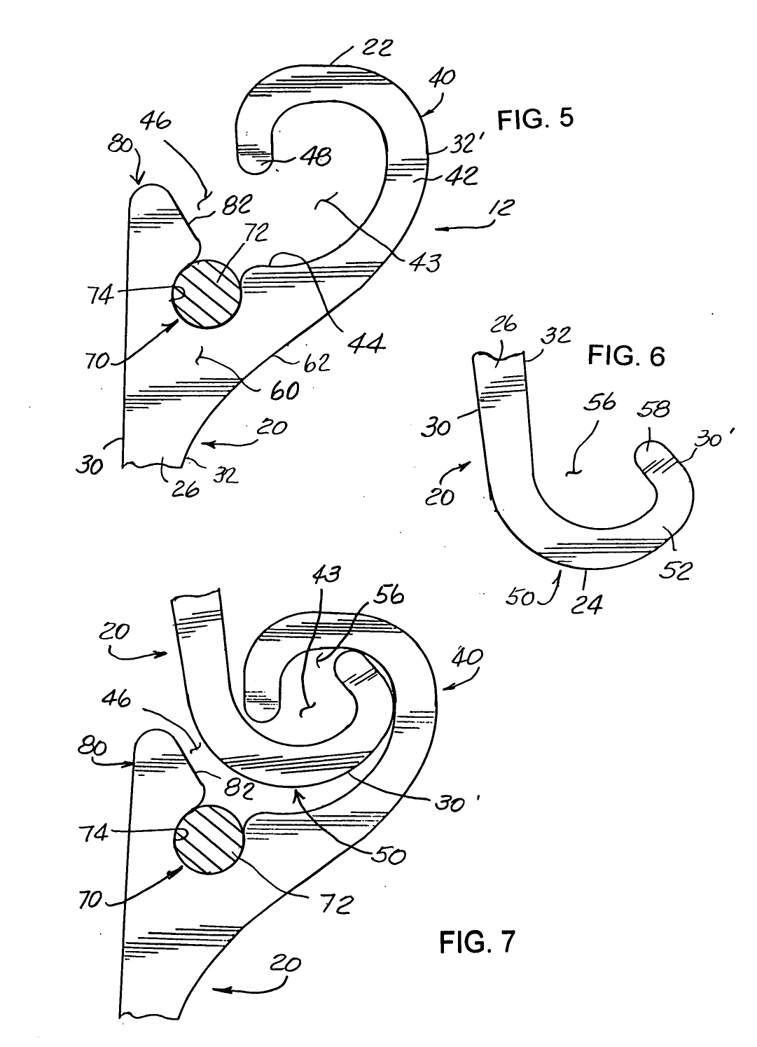

As shown in FIGS. 3 and 5, each plate member 20 is provided with an integral, first or upper hinge portion 40 extending longitudinally along the first or upper longitudinally extending edge 22. As shown, hinge portion 40 includes a spiral-like hook 42 preferably having a substantially continuous curvature, thus, providing a design with a low stress riser. In a preferred form, the spiral-like hook 42 has a curvature with a decreasing radial configuration as it extends from the body portion 26 toward a free end portion 48. Moreover, hook 42 defines a pocket or recess 43 extending longitudinally along the first or upper longitudinally extending edge 22. In one form, the material forming the spiral-like hook 42 has a thickness which is generally equal to or greater than the thickness of material between the forward or first face 30 and the rearward or second face 32 of the body portion 26 of each plate member 20.

The spiral-like hook 42 combines with a confronting surface 44 on the body portion 26 of plate member 20 to define a first open sided channel 46 leading and opening to the recess 43. As shown, the spiral-like hook 42 terminates in the free end portion 48. As shown in FIG. 3, the free end portion 48 of the spiral-like hook 42 is directed generally toward the lower marginal edge 24 of the plate member 20. In a preferred embodiment, the spiral-like hook 42 and channel 46 extend substantially continuously along substantially an entire length of the plate member 20. Notably, and in the embodiment illustrated in FIGS. 3 and 5, the free end portion 48 of the spiral-like hook 42 terminates relative to the confronting surface 44 on the body portion 26 of the plate member 20 by a distance equal to or slightly greater than a thickness of measured between the forward or front face 30 and the back or rear face 32 of the neck portion 28 of plate member 20.

Turning to FIG. 6, a lower or second hinge portion 50 extends longitudinally along edge 24 of each plate member 20. Like hinge portion 40, the second hinge portion 50 also includes a spiral-like hook 52 preferably having a substantially continuous curvature, thus, providing a plate design with a low stress riser. In a preferred form, the spiral-like hook 52 has a curvature with a decreasing radial configuration as it extends from the body portion 26 toward a free end portion 58. The spiral-like hook 52 combines with the rear face 32 on the body portion 26 of plate member 20 to define another or second open-sided channel 56. As shown, the spiral-like hook 52 terminates in the free end portion 58. In one form, the free-end portion 58 of the spiral-like hook 52 is directed generally toward the second or rear face 32 of the plate member 20.

In one form, the material forming the spiral-like hook 52 has a thickness generally equal to or greater than the thickness of material between the forward or first face 30 and the rearward or second face 32 of the body portion 26 of each plate member 20. Suffice it to say, the material forming the spiral-like hook 52 has a thickness which is generally equal to or slightly less than the size of the first open-sided channel 46 leading or opening to the recess 43 defined by the spiral-like hook 42. Notably, the spiral-like hook 52 is configured to allow the second or lower hinge portion 52 of a plate member 20 to longitudinally cooperate with and fit within the spiral-like hook 42 at the first or upper hinge portion of an adjacent shutter panel thereby forming a hinge joint therebetween. In a preferred embodiment, the spiral-like hook 52 and channel 56 extend substantially continuously along substantially an entire length of the plate member 20. Suffice it to say, an exterior surface 30′ of the spiral-like hook 52 is configured to loosely fit and rotate within the confines of the pocket or recess 43 defined by hook portion 42 when adjacent panel members 12 are fitted together to form shutter assembly 10 (FIGS. 1 and 2). As will be appreciated from an understanding of the invention, and after the panels are interconnected to each other, the free-ends 48 and 58 of the hooks 42 and 52, respectively, combine to limit rotational movements hinge portion 52 within the socket 43.

As shown in FIG. 7, the first hinge portion 40 is configured to matingly and pivotally engage in interlocking relationship with the second hinge portion 50 of an adjacent plate member in a hinge joint configured to allow up to about 90° of rotation between the adjacent and pivotally joined shutter panels. In the illustrated embodiment, the hook design 52 at the second hinge portion of each plate member 20 is configured slightly smaller in cross-sectional size than the pocket or recess 43 defined by hook portion 42 at the first hinge portion 40 of an adjacent panel.

To add to the structural strength of each shutter panel, and in the embodiment illustrated in FIGS. 3 and 5, the spiral-like hook 42 along the first or upper longitudinally extending edge 22 of plate member 20 transversely extends from an enlarged and transversely elongated section 60 formed integral with the body or intermediate portion 26 of each plate member 20. In the embodiment illustrated in FIGS. 3 and 6, the enlarged section 60 of the body or intermediate section 26 of each plate member 20 extends transversely from surface 44 defined by plate member 20 for a distance ranging between about 10% and about 50% of the overall length of the plate member 20. In the illustrated embodiment, the enlarged section 60 of the body or intermediate section 26 has a generally triangular cross-sectional configuration. Preferably, and to reduce stress concentrations, a curvilinear surface 62 is preferably provided to transition between the rear or second face 32 of the body portion 26 of plate member 20 and an exterior surface 32′ on the spiral-like hook portion 42. In a preferred embodiment, the enlarged section 60 extends substantially continuously along substantially an entire length of the plate member 20.

Preferably, each shutter panel 12 of assemblyl 10 (FIG. 10) is positively guided during its travel by conventional track or rail structure (not shown) mounted in the usual manner proximate opposed sides of the door/window opening to be covered and protected by the shutter assembly 10. In one form, a securement apparatus, generally identified in FIGS. 5 and 7 by reference numeral 70, is mounted toward opposed sides or ends 27, 29 (FIG. 3) of each shutter panel 12 for operable combination with such rail or track structure. Apparatus 70 typically includes an elongated and generally cylindrical connector 72 (FIG. 5) suitably mounted toward each side or end 27, 29 (FIG. 3) of each shutter panel 12.

As shown in FIGS. 3, 5 and 7, each plate member 20 is preferably configured with an longitudinally elongated bore 74 formed integral with and opening to each side or end 27, 29 (FIG. 3) of the plate member 20 for receiving and accommodating at least a lengthwise section of the connector 72. Preferably, such bore or opening 74 is defined by the enlarged section 60 of the plate member 20. It should be appreciated, however, the elongated bore or aperture 74 can be defined by the plate member 20 substantially anywhere between the longitudinal edges 22, 24 without detracting or departing from the spirit and scope of the present invention. Alternatively, a suitable mounting bracket (not shown), which carries the connector 72 of apparatus 70, can likewise be suitably secured toward each side or end 27, 29 of the plate member 20.

Each plate member 20 is further configured with structure 80 for to inhibiting inadvertent separation of pivotally linked or joined first and second hinge portions 40 and 50, respectively, on adjacent shutter panels 12. In the embodiment illustrated in FIGS. 3, 5 and 7, structure 80 includes a surface 82 disposed in opposed and spaced relation relative to the free end portion 48 of the spiral-like hook 42 and which serves as an extension of the surface 44 defining, at least partially, the open sided channel 46 on plate member 20. Preferably, and as shown in FIG. 7, structure 80 has a cantilevered or free-ended design and extends substantially continuously along substantially the entire length of plate member 20. As will be appreciated from an understanding thereof, structure 80 serves as a “tail trap” for inhibiting the second spiral-like hook 52 from “backing out” of the channel 46 after hinge portions 40 and 50 of two adjacent panels 12 are interlocked relative to each other.

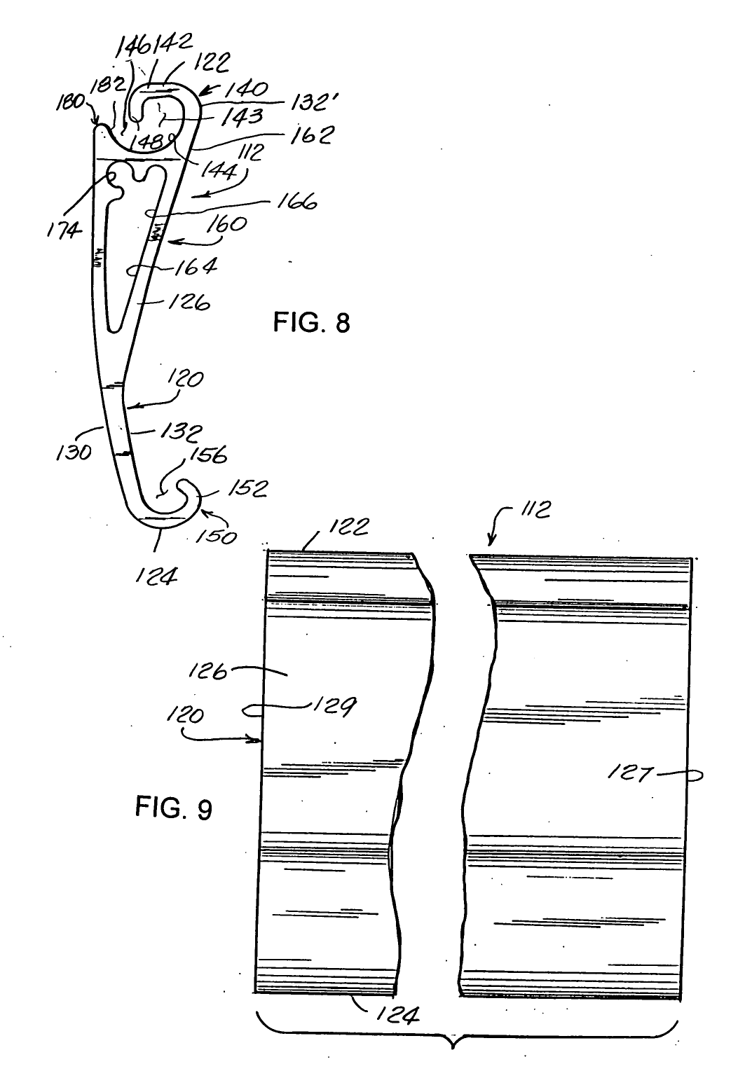

Another embodiment of a shutter panel according to the present invention is shown in FIGS. 8 and 9 and is designated therein by reference numeral 112. Shutter panel 112 is similar in structure and function to the above-described shutter panel 12. The elements of this alternative embodiment that are identical or functionally analogous to those of the embodiment described above are designated by reference numerals identical to those used for the earlier described embodiment with the exception this embodiment uses reference numerals in the 100 series.

Each shutter panel 112 is preferably formed from a relatively thin walled, unitary plate member 120 preferably using an extrusion process. As shown in FIGS. 8 and 9, each plate member 120 has a first longitudinally extending edge 122 and a second longitudinally extending edge 124 transversely spaced from and extending generally parallel to edge 122. Each plate member 120 also includes a body portion 126 extending transversely between edges 122 and 124 and having a forward or front face 130 and a back face 132. In the illustrated embodiment, the front face 130 and back face 132 are generally parallel to each other and each has a curvilinear configuration in cross-section. As shown in FIG. 9, the body portion 126 of plate member 120 terminates in longitudinally spaced and generally parallel sides or ends 127 and 129 defining the horizontal length of each panel 112 therebetween.

As shown in FIG. 8, each plate member 120 is provided with an integral, first or upper hinge portion 140 extending longitudinally along the first or upper longitudinally extending edge 122. As shown, hinge portion 140 includes a spiral-like hook 142 which is substantially similar to the hook 42 described above. In the form shown, hook 142 of plate member 120 preferably has a substantially continuous curvature, thus, providing a design with a low stress riser. In a preferred form, hook 142 has a curvature with a decreasing radial configuration as it extends from the body portion 126 toward a free end portion 148. Moreover, hook 142 defines a pocket or recess 143 which, in the illustrated embodiment, extends substantially continuously and longitudinally along the entire length of the first or upper longitudinally extending edge 122.

A lower or second hinge portion 150 extends longitudinally along the longitudinally extending edge 124 of each plate member 120. Like hinge portion 50, the second hinge portion 150 also includes a spiral-like hook 152 preferably having a substantially continuous curvature, thus, providing a plate design with a low stress riser. In a preferred form, hook 152 has a curvature with a decreasing radial configuration as it extends from the body portion 126 toward a free-end portion 158. Hook 152 combines with the rear face 132 on the body portion 126 of plate member 120 to define another or second open sided channel 156 which, in the illustrated embodiment extends substantially continuously and longitudinally along the entire length of the first or upper longitudinally extending edge 124.

As with the above-described design, the first hinge portion 140 of plate member 120 is configured to matingly and pivotally engage in interlocking relationship with the second hinge portion 150 of an adjacent plate member in a hinge joint configured to allow up to about 90° of rotation between the adjacent and pivotally joined shutter panels. In the illustrated embodiment, the hook design 152 at the second hinge portion of each plate member 120 is configured slightly smaller in cross-sectional size than the pocket or recess 143 defined by hook portion 142 at the first hinge portion 140 of an adjacent shutter panel.

In the embodiment illustrated in FIGS. 8 and 9, the body 126 of the plate member 120 has a section 160 which is transversely elongated when compared with section 60 shown above in FIGS. 3 and 5. Notwithstanding the transverse elongation thereof, section 160 remains formed integral with the body or intermediate portion 126 of each plate member 120. In the embodiment illustrated in FIG. 8, section 160 of the body or intermediate section 126 of each plate member 120 extends transversely of plate member 120 for a distance ranging between about 30% and about 60% of the overall length of the plate member 20.

In the embodiment shown in FIG. 8, section 160 of the body or intermediate section 126 has a generally triangular and hollow cross-sectional configuration. Preferably, a curvilinear surface 162 transitions between the rear or second face 132 of the body portion 126 of plate member 120 to an exterior surface 132′ on the hook 142. In a preferred embodiment, section 160 extends substantially continuously along substantially an entire length of the plate member 120.

One of the principal differences between plate member 20 and plate member 120, shown in FIG. 8, relates to configuring the body portion 126 with an elongated opening or cavity 164 having a closed margin 166 and which transversely extends between the first and second edges 122 and 124, respectively, of plate member 120. In the embodiment shown in FIG. 8, the opening or cavity 164 defined by the enlarged section 160 of the body or intermediate section 126 of plate member 120 has a generally triangular cross-sectional configuration so as to maintain a generally consistent wall thickness for the plate member 120, thus, facilitating extrusion of the plate member 120. It should be appreciated, the body or intermediate section 126 of plate member 120 can define more than one cavity having a closed margin without detracting from the invention. Preferably, the opening or cavity 164 defined by the enlarged section 160 of the body section 126 extends substantially continuously along the entire length of plate member 120.

Another difference between plate member 20 and plate member 120 relates to the provision of a longitudinally elongated bore 174 being arranged in transversely spaced disposition relative to the position of bore 74 mentioned above. In the embodiment shown in FIG. 8, the opening or bore 174 is preferably arranged as part of the opening or cavity 164 formed in the body portion 126 of plate member 120. In a preferred embodiment, and to reduce the weight of plate member 120, the opening or bore 174 extends substantially continuously along substantially the entire length of plate member 120. Suffice to to say, the opening or bore 174 opens to each side or end 127, 129 (FIG. 9) of plate member 120 for receiving and accommodating at least a lengthwise section of the connector 72 (FIG. 5). It should be appreciated, however, and as shown above, the bore or aperture 174 can be otherwise defined by the plate member 120 without detracting or departing from the spirit and scope of the present invention.

As mentioned above, each plate member 120 is configured with structure 180 for inhibiting inadvertent separation of pivotally linked or joined first and second hinge portions 140 and 150, respectively, on adjacent shutter panels 12. In the embodiment illustrated in FIG. 8, structure 180 has a cantilevered or free-ended design having a surface 182 disposed in opposed and spaced relation relative to a free-end portion 148 of the hook 142 and which serves as an extension of surface 144 defining, at least partially, an open sided channel 146 on plate member 120. Structure 180 preferably extends substantially continuously along substantially the entire length of plate member 120. As will be appreciated, structure 180 serves as a “tail trap” for inhibiting the second spiral-like hook 152 from “backing out” of the channel 146 after hinge portions 140 and 150 of two adjacent panels 12 are interlocked relative to each other.

In summary, a shutter panel for a roll-type shutter assembly for protecting either a window or door has been disclosed and described. The construction of a shutter assembly using shutter panels formed from plate members 20 will be described for exemplary purposes. It will be appreciated, however, and because of the structural similarities therebetween, a shutter assembly formed from plate members 120 is constructed in a substantially similar fashion. Initially, the plate members forming each shutter panel are cut to their required lengths. The hinge portion 50 of one unitary plate member is simply slid lengthwise into the cavity or recess 43 of an adjacent unitary plate member 20 thus forming an interlocking hinge or pivot joint between the two adjacent shutter panels. The assembled shutter panels can then be secured to an appropriate roller or shaft in the conventional manner using a conventionally constructed roller or shaft.

The hinge portions 40, 50 on adjacent shutter panels allow the hooks 42, 52 to rotate relative to each other whereby permitting the shutter panels to move between a generally vertical disposition relative to each other (FIG. 1) to a position wherein the hinge portions allow for up to about 90° of rotation relative to each other (FIG. 2). Advantageously, the plate members can have relatively large tolerance variations, i.e., 5 mm in cross-section through the body portion and hooks 42, 52 and 1 mm on placement of the hooks 42, 52, without degrading or adversely affecting structural performance characteristics of the panel members. Moreover, the relatively large radius of curvature of the hook portions 42, 52 reduces the stress risers due to the substantially continuous curvature.

Another advantageous feature of the invention relates to the protection afforded by the unique design of the present invention. The above-disclosed shutter panel design offers an approximate intrusion of about 50 mm when a 9 lb. 2″×4″ wood object impacts at velocities up to about 55 mph against the outer surface of the shutter panel. Of course, and with only slight modifications to the thickness of material and/or type of material used to form the plate member, the protectiveness of the invention significantly increases. Whereas, some plate members having a substantially similar design to that described above but formed from an aluminum alloy have offered surprising test results of only about 130 mm of deflection when a 9 lb. 2″×4″ wood object impacts at up to 100 mph. against the outer surface of the shutter panel.

Moreover, the tail trap structure 80 on each panel member, preferably formed as an integral part of each plate member, inhibits the conjoined and pivotally interconnected hinge portions 40, 50 on adjacent shutter panels from inadvertently separating from each other. As such, the shutter panel of this invention offers both enhanced protection as well as operational integrity.

From the foregoing, it will be observed that numerous modifications and variations can be made and effected without departing or detracting from the true spirit and novel concept of the present invention. Moreover, it will be appreciated, the present disclosure is intended to set forth an exemplification of the invention which is not intended to limit the invention to the specific embodiment illustrated. Rather, this disclosure is intended to cover by the appended claims all such modifications and variations as fall within the spirit and scope of the claims.

What is claimed is:

1. A protective shutter panel for a roll-up shutter assembly, said protective shutter panel comprising:
a unitary plate member having first and second generally parallel and longitudinally extending edges, with said plate member also having an intermediate portion terminating in longitudinally spaced ends and having a transverse cross-sectional configuration so as to allow a maximum of 50 mm displacement of said intermediate portion when a 9 lb. 2′×4″ wood object traveling at a 55 mph velocity impacts thereagainst; with said plate member having a first hinge portion along the first edge thereof, with said first hinge portion including a spiral-like hook which combines with a surface on said plate member to define a first open-sided channel leading to a pocket; and with said plate member having a second hinge portion along the second edge thereof, with the second hinge portion including a spiral-like hook which defines a second open-sided channel; and wherein the pocket defined by said first hinge portion is configured to matingly and pivotally engage with the spiral-like hook of second hinge portion on an adjacent protective shutter panel in a hinge joint configured to allow for up to about 90° of rotation between said adjacent and pivotally joined shutter panels.

2. The protective shutter panel according to claim 1, wherein said plate member further includes structure for inhibiting inadvertent separation of said first and second hinge portions on adjacent panels relative to each other.

3. The protective shutter panel according to claim 1, wherein the intermediate portion of said plate member has a generally curvilinear outer surface configuration between said first and second longitudinal edges.

4. The protective shutter panel according to claim 1, wherein said plate member is formed using an extrusion process so as to promote interchangability between said panel members.

5. The protective shutter panel according to claim 1, wherein the open sided channel defined by said first hinge portion is sized equal to or slightly larger than a cross-sectional thickness of material between inner and outer surfaces of that portion of said plate member extending toward the second hinge portion.

6. The protective shutter panel according to claim 1, wherein an outer surface of said spiral-like like hook at the second hinge portion is sized equal to or slightly smaller in cross-section than the pocket defined by said first hinge portion so as to allow said first and second hinge portions to slide longitudinally one within the other.

7. The protective shutter panel according to claim 1, wherein a section of the intermediate portion of said plate member has a generally triangular cross-sectional configuration between said first and second longitudinal edges of said plate member.

8. The protective shutter panel according to claim 1, wherein said plate member defines, between said first and second longitudinal edges, an opening configured to longitudinally receive and captively hold a connector of a securement apparatus.

9. The protective shutter panel according to claim 1, wherein said intermediate portion of said plate member defines an opening with a closed margin transversely extending between said first and second longitudinal edges of said plate member.

10. The protective shutter panel according to claim 9, wherein the closed margin of the opening transversely extending between said first and second longitudinal edges of said plate member is configured to longitudinally receive and captively hold a connector of a securement apparatus.

11. A protective shutter panel for a roll-up protective shutter assembly, said protective shutter panel comprising:
a unitary plate member having first and second generally parallel and longitudinally extending edges with a body portion extending between said edges and including front and rear surfaces, with the body portion of said plate member terminating in longitudinally spaced ends and having a configuration so as to allow a maximum of 50 mm displacement of said body portion when a 9 lb. 2″×4″ wood object traveling at a 55 mph velocity impacts thereagainst; with said plate member having a first hinge portion along the first edge thereof, said first hinge portion including a spiral-like and free-ended hook which combines with a longitudinally extending surface on said plate member to define a first open-sided channel leading to a pocket; and with said plate member having a second hinge portion along the second edge thereof, said second hinge portion including a spiral-like and free-ended hook which combines with a surface on said plate member to define a second open-sided channel, and wherein the open-sided channels defined by said first and second hinge portions allow the free-ended first and second hooks of adjacent panel members to be interlocked relative to each other while permitting said adjacent panels members to rotate through an arc of about 90° relative to each other; and with said plate member further including structure for inhibiting inadvertent separation of said first and second free ended hinge portions on adjacent panels relative to each other.

12. The protective shutter panel according to claim 11, wherein the front surface of said body portion of said plate member has a generally curvilinear configuration between said first and second longitudinal edges.

13. The protective shutter panel according to claim 11, wherein the free-end of each hook terminates relative to the respective confronting surface of said plate member by a distance equal to or greater than a thickness of material between the front and rear surfaces of said plate member.

14. The protective shutter panel according to claim 11, wherein an outer surface of said spiral-like hook at the second hinge portion has a curvature which is equal to or slightly smaller in cross-sectional size than the first open-sided channel defined by the first hinge portion so as to allow said first and second free ended hinge portions to slide longitudinally one within the other.

15. The protective shutter panel according to claim 11, wherein a transverse width section of the body portion of said plate member has a generally triangular cross-sectional configuration between said first and second longitudinal edges of said plate member.

16. The protective shutter panel according to claim 11, wherein the body portion of said plate member defines, between said first and second longitudinal edges, an opening configured to longitudinally receive and captively hold a connector of a securement apparatus.

17. The protective shutter panel according to claim 11, wherein the body portion of said plate member has an opening with a closed margin transversely extending between said inner and outer surfaces and between the first and second longitudinal edges of said plate member.

18. A protective shutter panel for roll-type shutter assembly, said protective shutter panel comprising:
a horizontally elongated one-piece plate member having an upper longitudinal edge, a lower longitudinal edge, and a body portion transversely extending between said edges and terminating in longitudinally spaced ends, with said body portion of sail plate member defining a forward face and rear face; with the upper edge of said plate member being formed with a first hook having a spiral-like curved portion terminating in a free-end portion, with said free-end portion of said first hook being directed generally toward the lower marginal edge of said plate member, and wherein said first hook combines with said plate member to define a first open-sided channel; and with the lower edge of said plate member being formed with a second hook having a spiral-like curved portion terminating in a free-end portion, with said free-end portion of said second hook being directed generally toward the rear face of said plate member, and wherein said first hook combines with said plate member to define a first open-sided channel, and wherein the second hook combines with the plate member to define a second open sided channel; and wherein the open-sided channels defined by said first and second hooks and the plate member are configured to allow adjacent shutter panels to be interlocked relative to each other while permitting said adjacent shutter panels to rotate through an arc of about 90° relative to each other; and with said plate member further including structure for inhibiting inadvertent separation of said first and second free ended hooks on adjacent shutter panels relative to each other.

19. The shutter panel according to claim 18, wherein said hooks and channels each extend substantially continuously along substantially an entire length of their respective shutter panel.

20. The shutter panel according to claim 18, wherein each plate member is formed from a thin walled extrusion with the body portion of each plate member being hollow.

21. The shutter panel according to claim 18, wherein the body portion of said plate member defines, between the upper and lower longitudinal edges, an opening configured to longitudinally receive and captively hold a connector of a securement apparatus.

22. The shutter panel according to claim 18, wherein the body portion of said panel member has an opening with a closed margin transversely extending between the forward face and rear face and between the upper and lower longitudinal edges of said plate member.

23. The shutter panel according to claim 22, wherein the closed margin of the opening transversely extending between said upper and lower longitudinal edges of said plate member is configured to longitudinally receive and captively hold a connector of a securement apparatus.

24. A method of making a protective shutter panel for a roll-up shutter assembly, comprising the steps of:
extruding a panel having first and second generally parallel and longitudinally extending edges, with said panel also having an intermediate portion terminating in longitudinally spaced ends and having a transverse cross-sectional configuration so as to allow a maximum of 50 mm displacement of said intermediate portion when a 9 lb. 2″×4″ wood object traveling at a 55 mph velocity impacts thereagainst; with said panel having a first hinge portion along the first edge thereof, with said first hinge portion including a spiral-like hook which combines with a surface on said panel member to define a first open-sided channel leading to a pocket; and with said panel having a second hinge portion along the second edge thereof, with the second hinge portion including a spiral-like hook defining a second open-sided channel; and wherein the pocket defined by said first hinge portion is configured to matingly and pivotally engage with the spiral-like hook of second hinge portion on an adjacent protective shutter panel in a hinge joint configured to allow for up to about 90° of rotation between said adjacent and pivotally joined shutter panels.
